(19) United States
(12) Patent Application Publication
(10) Pub. No.: US 2007/0143626 A1
(43) Pub. Date: Jun. 21, 2007

(54) Data forming apparatus and method for data security

(75) Inventor: Masaya Okuda, Osaka (JP)

Correspondence Address: GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 11/306,204

(22) Filed: Dec. 20, 2005

(51) Int. Cl. H04L 9/00

(52) U.S. Cl. 713/183

(57) ABSTRACT

A system and an apparatus for establishing the security of data comprises: a storage unit that stores data; an overwrite-erasing unit that performs an overwrite-erasure of the data stored in the storage unit; and a management unit that analyzes a password that has been entered for an access to the data. The analysis includes determining whether the password should be authorized or unauthorized and making the password authorized or unauthorized. The analysis also includes counting the number of password entries that have been unauthorized by the password authorization unit. The analysis also includes verifying whether or not the password has an unallowable level of password-regularity. The analysis also includes counting a time period between a last password entry time and a latest password entry time to compares the measured time period to a predetermined reference time period.

### BACKGROUND OF THE INVENTION

1. Field of the Invention

The present invention generally relates to an apparatus and a security program for outputting data stored in a storage unit based on password identification. More specifically, the present invention relates to an apparatus and a security program that performs various analyses of a password in order to prevent any unauthorized inspections, leakage and use of confidential data through unauthorized access, thereby establishing the security of a confidential data management system.

2. Description of the Related Art

All patents, patent applications, patent publications, scientific articles, and the like, which will hereinafter be cited or identified in the present application, will hereby be incorporated by references in their entirety in order to describe more fully the state of the art to which the present invention pertains.

A typical storage unit such as a hard disk for computers is generally configured to permit not only authorized user but also any unauthorized user to store, use, display, or output confidential data such as company or private information. Effective countermeasures have been required to prevent unauthorized persons from obtaining such confidential information and to avoid security problems with the company or individual.

A conventional security system for an image forming apparatus has been proposed, in which identification and/or password authorization is required. When any unauthorized access to confidential data is detected by the security system, the confidential data is then erased by the system in order to prevent the unauthorized user from obtaining the confidential data.

Japanese Laid-open Patent Publication No. 2003-150360 discloses such a conventional security system, in which when a greater number of unauthorized access attempts than a predetermined reference number is detected, the confidential data or information will be erased promptly. However, this conventional system can incorrectly determine that the entry of an erroneous ID or password by an authorized user is an unauthorized access to the confidential data, and thus, the system will erase the confidential data that should not have to be erased.

Further, the conventional system merely erases data by leaving the content of the data while deleting the management information of the data, so that recovery of the data is possible. This means that an unauthorized user can recover the data and obtain the confidential information.

Furthermore, a conventional system is not configured to inform an authorized user and/or a system manager of the attempt at unauthorized access to the confidential data.

In view of the above, it will be apparent to those skilled in the art from this disclosure that there exist the needs for an improved image forming apparatus and an improved security system. This invention addresses these needs in the art as well as other needs, which will become apparent to those skilled in the art from this disclosure.

### SUMMARY OF THE INVENTION

Accordingly, it is a primary object of the present invention to provide an apparatus that is free from the above-described problems and disadvantages.

It is another object of the present invention to provide a data security system and program that make the apparatus free from the above-described problems and disadvantages.

In order to achieve the above-described objects of the present invention, a password that is entered in order to access data is subjected to a unique analysis in order to determine or judge whether or not access with the password should be authorized or unauthorized. When access is unauthorized, the data is subjected to over-write erasure that makes it impossible to recover the erased data. In addition, an authorized user and/or a system manager are advised of the fact that unauthorized access to the confidential data was attempted.

In accordance with a first aspect of the present invention, an apparatus is provided, which comprises: a storage unit that stores data; an overwrite-erasing unit that performs an overwrite-erasure of the data stored in the storage unit; and a management unit that analyzes a password that has been entered in order to access the data in order to determine whether the access should be authorized or unauthorized. The management unit sends the overwrite-erasing unit a first request for the overwrite-erasure when access is unauthorized, or sends the storage unit a second request which authorizes access to the data when access is authorized. The apparatus can provide highly reliable security for data management.

It is preferable that the management unit further comprises: a password authorization unit that determines whether the password is authorized or unauthorized, and makes the password authorized or unauthorized; and an unauthorized-password counter unit that counts the number of password entries that were not authorized by the password authorization unit. The unauthorized-password counter unit verifies whether or not the counted number exceeds a predetermined reference number, and the unauthorized-password counter unit sends the overwrite-erasing unit the first request for the overwrite-erasure when the counted number exceeds the reference number. Namely, the management unit recognizes that access should be unauthorized when the counted number exceeds the reference number.

The password authorization unit and the unauthorized-password counter unit are configured to cooperate with each other to analyze the password as follows. If an entered password is not identical with the reference password that has previously been set for the subject data, then the entered password is unauthorized. The number of password entries that are unauthorized is calculated. If this number exceeds the predetermined reference number, then access is unauthorized, which is accompanied with the password entries that have been unauthorized. The data, to which unauthorized access was attempted, is then subjected to over-write erasure that makes it impossible to recover the erased data.

It is also preferable that the management unit further comprises: a password-regularity-detecting unit that verifies whether or not the password has an unallowable level of password-regularity. The password-regularity-detecting unit sends the overwrite-erasing unit the first request for overwrite-erasure when the password has an unallowable level of password-regularity.

The password-regularity-detecting unit is configured to analyze the password as follows. If an entered password has the predetermined unallowable level of password-regularity, then access with this entered password is also unauthorized. The data, to which the unauthorized access was attempted, is then subjected to over-write erasure that makes it impossible to recover the data. The password-regularity-detecting unit detects the regularity with reference to an arithmetical series or a character series, e.g., an arithmetical progression or a geometrical progression. The password-regularity-detecting unit can detect unauthorized access by Brute Force Attack.

It is also preferable that the management unit further comprises: an elapsed-time-calculating unit that measures the time period between the last password entry time and the latest password entry time that is subsequent to the last password entry time. The elapsed-time-calculating unit compares the measured time period to a predetermined reference time period, and sends the overwrite-erasing unit the first request for the overwrite-erasure when the measured time period is equal to or less than the reference time period.

The elapsed-time-calculating unit is configured to analyze the password as follows. A time period is measured between the last password entry time and the latest password entry time subsequent to the last password entry time. If the measured time period is equal to or less than the predetermined reference time period, then access accompanied with the last and latest password entries is unauthorized. The data, to which unauthorized access was attempted, is then subjected to over-write erasure that makes it impossible to recover the erased data.

It is also preferable that the management unit further comprises: a password authorization unit that determines whether the password should be authorized or unauthorized, and makes the password authorized or unauthorized; an unauthorized-password counter unit that counts the number of password entries that have been unauthorized by the password authorization unit to verify whether or not the counted number exceeds a predetermined reference number, wherein unauthorized-password counter unit sends the overwrite-erasing unit the first request for the overwrite-erasure when the counted number exceeds the reference number; and a password-regularity-detecting unit that verifies whether or not the password has an unallowable level of password-regularity, wherein password-regularity-detecting unit sends the overwrite-erasing unit the first request for the overwrite-erasure when the password has the unallowable level of password-regularity.

The password authorization unit, the unauthorized-password counter unit and the password-regularity-detecting unit are configured to cooperate with each other to analyze the password as follows. If an entered password is not identical with the reference password that has previously been set for the subject data, then the entered password is unauthorized. The number of password entries that are unauthorized is counted. If the counted number exceeds the predetermined reference number, then this access is unauthorized, which is accompanied with the password entries that are not unauthorized. The data, to which the unauthorized access was attempted, is then subjected to over-write erasure that makes it impossible to recover the erased data. If an entered password has the predetermined unallowable level of password-regularity, then the access with this entered password is also unauthorized. The data, to which the unauthorized access was attempted, is then subjected to over-write erasure that makes it impossible to recover the data.

It is also preferable that the management unit further comprises: a password entry unit that enters the password into the password authorization unit; and a delay unit that delays requesting the password entry unit for a password entry again after the password is made unauthorized by the password authorization unit.

The delay in requesting the password entry unit for another password entry makes it difficult to enter many passwords in a short time period. This contributes to inhibiting any access that should be unauthorized. If an entered password has the predetermined unallowable level of password-regularity, then access with this entered password is also unauthorized. The data, to which the unauthorized access was attempted, is then subjected to over-write erasure that makes it impossible to recover the erased data.

It is moreover preferable that the management unit further comprises: a password authorization unit that determines whether the password should be authorized or unauthorized, and makes the password authorized or unauthorized; an unauthorized-password counter unit that counts the number of password entries that have been unauthorized by the password authorization unit to verify whether or not the counted number exceeds a predetermined reference number, wherein the unauthorized-password counter unit sends the overwrite-erasing unit the first request for the overwrite-erasure when the counted number exceeds the reference number; and an elapsed-time-calculating unit that counts a time period between a last password entry time and a latest password entry time that is subsequent to the last password entry time, wherein the elapsed-time-calculating unit compares the measured time period to a predetermined reference time period, and sends the overwrite-erasing unit the first request for the overwrite-erasure when the measured time period is equal to or less than the reference time period.

The password authorization unit, the unauthorized-password counter unit and the elapsed-time-calculating unit are configured to cooperate with each other to analyze the password as follows. If an entered password is not identical with the reference password that has previously been set for the subject data, then the entered password is unauthorized. The number of password entries that are unauthorized is counted. If the counted number exceeds the predetermined reference number, then this access is unauthorized, which is accompanied with the password entries that are unauthorized. The data, to which the unauthorized access was attempted, is then subjected to over-write erasure that makes it impossible to recover the once-erased data. Further, a time period is measured between the last password entry time and the latest password entry time subsequent to the last password entry time. If the measured time period is equal to or less than the predetermined reference time period, then access accompanied with the last and latest password entries is unauthorized. The data, to which the unauthorized access was attempted, is then subjected to over-write erasure that makes it impossible to recover the once-erased data.

It is still more preferable that the management unit further comprises: a password-regularity-detecting unit that verifies whether or not the password has an unallowable level of password-regularity, and the password-regularity-detecting unit that sends the overwrite-erasing unit the first request for the overwrite-erasure when the password has the unallowable level of password-regularity; and a elapsed-time-calculating unit that counts a time period between a last password entry time and a latest password entry time that is subsequent to the last password entry time, and the elapsed-time-calculating unit that compares the measured time period to a predetermined reference time period, and sends the overwrite-erasing unit the first request for the overwrite-erasure when the measured time period is equal to or less than the reference time period.

The password-regularity-detecting unit and the elapsed-time-calculating unit are configured to cooperate with each other to analyze the password as follows. If an entered password has the predetermined unallowable level of password-regularity, then the access with this entered password is also unauthorized. The data, to which the unauthorized access was attempted, is then subjected to over-write erasure that makes it impossible to recover the once-erased data. A time period is measured between the last password entry time and the latest password entry time subsequent to the last password entry time. If the measured time period is equal to or less than the predetermined reference time period, then the access accompanied with the last and latest password entries is unauthorized. The data, to which the unauthorized access was attempted, is then subjected to over-write erasure that makes it impossible to recover the once-erased data.

It is yet more preferable that the management unit further comprises: a password authorization unit that determines whether the password should be authorized or unauthorized, and makes the password authorized or unauthorized; an unauthorized-password counter unit that counts the number of password entries that have been unauthorized by the password authorization unit to verify whether or not the counted number exceeds a predetermined reference number, and the unauthorized-password counter unit sends the overwrite-erasing unit the first request for the overwrite-erasure when the counted number exceeds the reference number; a password-regularity-detecting unit that verifies whether or not the password has an unallowable level of password-regularity, and the password-regularity-detecting unit that sends the overwrite-erasing unit the first request for the overwrite-erasure when the password has the unallowable level of password-regularity; and a elapsed-time-calculating unit that counts a time period between a last password entry time and a latest password entry time that is subsequent to the last password entry time, and the elapsed-time-calculating unit that compares the measured time period to a predetermined reference time period, and sends the overwrite-erasing unit the first request for the overwrite-erasure when the measured time period is equal to or less than the reference time period.

The password authorization unit, the unauthorized-password counter unit, the password-regularity-detecting unit and the elapsed-time-calculating unit are configured to cooperate with each other to analyze the password as follows. If an entered password is not identical with the reference password that has previously been set for the subject data, then the entered password is denied. The number is counted of the password entries that have been denied. If the counted number exceeds the predetermined reference number, then this access is unauthorized, which is accompanied with the password entries that have been denied. The data, to which the unauthorized access was attempted, is then subjected to over-write erasure that makes it impossible to recover the once-erased data. If an entered password has the predetermined unallowable level of password-regularity, then the access with this entered password is also unauthorized. The data, to which the unauthorized access was attempted, is then subjected to over-write erasure that makes it impossible to recover the once-erased data. Further, a time period is measured between the last password entry time and the latest password entry time subsequent to the last password entry time. If the measured time period is equal to or less than the predetermined reference time period, then the access accompanied with the last and latest password entries is unauthorized. The data, to which the unauthorized access was attempted, is then subjected to over-write erasure that makes it impossible to recover the once-erased data.

It is also preferable that the apparatus further comprises: a notification unit that sends a predetermined destination a notice to the effect that the overwrite-erasing unit will perform or has performed the overwrite-erasure. This notification unit allows the user and/or system manager possessing the email destination to take any additional countermeasure to prevent any further unauthorized access.

It is also preferable that the management unit sends the overwrite-erasing unit a third request for the overwrite-erasure, after the access had been authorized and the data has been fetched from the storage unit. The used data might, in case, be no longer needed to be used again. In this case, it can be effective for the security to erase the data so as to make it impossible to recover the once-erased data. In addition, it is possible to use memory space effectively because unnecessary data does not the memory space.

Note that each unit of the present invention described above can be electrically connected to each other via a wired or wireless network.

In accordance with a second aspect of the present invention, a storage medium containing executable instructions that, when executed, cause a processor to perform the steps comprising: analyzing a password that has been entered for an access to data stored on a storage unit in order to determine whether the access should be authorized or unauthorized; performing an overwrite-erasure of the data when making the access unauthorized; and allowing access to the data when making the access authorized.

It is preferable that the step of analyzing the password further comprises determining whether the password should be authorized or unauthorized, and making the password authorized or unauthorized; and counting the number of password entries that have been unauthorized to verify whether or not the counted number exceeds a predetermined reference number. The step of performing the overwrite-erasure further comprises performing the overwrite-erasure when the counted number exceeds the reference number.

It is also preferable that the step of analyzing the password further comprises verifying whether or not the password has an unallowable level of password-regularity. The step of performing the overwrite-erasure further comprises performing the overwrite-erasure when the password has the unallowable level of password-regularity.

It is also preferable that the step of analyzing the password further comprises counting a time period between a last password entry time and a latest password entry time that is subsequent to the last password entry time; and comparing the measured time period to a predetermined reference time period. The step of performing the overwrite-erasure further comprises performing the overwrite-erasure when the measured time period is equal to or less than the reference time period.

It is also preferable that the step of analyzing the password further comprises determining whether the password should be authorized or unauthorized, and making the password authorized or unauthorized; and delaying a request to re-enter another password after the password is made unauthorized.

It is also preferable that the storage medium further comprises executable instructions that, when executed, cause a processor to send a predetermined destination a notice to the effect that the overwrite-erasure will be performed or has been performed.

It is also preferable that the computer program product further comprises executable instructions that, when executed, cause a processor to perform the overwrite-erasure after the access had been authorized and the data has been used.

In accordance with a third aspect of the present invention, a method comprises the steps of: analyzing a password that has been entered for an access to data stored in a storage unit in order to determine whether the access should be authorized or unauthorized; performing an overwrite-erasure of the data when making the access unauthorized; and allowing access to the data when making the access authorized.

It is preferable that the step of analyzing the password further comprises determining whether the password should be authorized or unauthorized, and making the password authorized or unauthorized; and counting the number of password entries that have been unauthorized to verify whether or not the counted number exceeds a predetermined reference number. The step of performing the overwrite-erasure further comprises performing the overwrite-erasure when the counted number exceeds the reference number.

It is also preferable that the step of analyzing the password further comprises verifying whether or not the password has an unallowable level of password-regularity. The step of performing the overwrite-erasure further comprises performing the overwrite-erasure when the password has the unallowable level of password-regularity.

It is also preferable that the step of analyzing the password further comprises counting a time period between a last password entry time and a latest password entry time that is subsequent to the last password entry time; and comparing the measured time period to a predetermined reference time period. The step of performing the overwrite-erasure further comprises performing the overwrite-erasure when the measured time period is equal to or less than the reference time period.

It is also preferable that the step of analyzing the password further comprises determining whether the password should be authorized or unauthorized, and making the password authorized or unauthorized; and delaying a request to re-enter another password after the password is made unauthorized.

It is also preferable that the method further comprise the step of sending a predetermined destination a notice to the effect that the overwrite-erasure will be performed or has been performed.

It is also preferable that the method further comprise the step of performing the overwrite-erasure after the access had been authorized and the data has been used.

In accordance with the present invention, the analysis of the password can be made under the following three conditions. First, if an entered password is not identical with the reference password that has previously been set for the subject data, then the entered password is denied. The number of password entries that have been denied is counted. If the counted number exceeds the predetermined reference number, then this access is unauthorized, which is accompanied with the password entries that have been denied. The data, to which the unauthorized access was attempted, is then subjected to over-write erasure that makes it impossible to recover the once-erased data.

Second, if an entered password has the predetermined unallowable level of password-regularity, then the access with this entered password is also unauthorized. The data, to which the unauthorized access was attempted, is then subjected to over-write erasure that makes it impossible to recover the once-erased data.

Third, a time period is measured between the last password entry time and the latest password entry time subsequent to the last password entry time. If the measured time period is equal to or less than the predetermined reference time period, then the access accompanied with the last and latest password entries is unauthorized. The data, to which the unauthorized access was attempted, is then subjected to over-write erasure that makes it impossible to recover the once-erased data.

These and other objects, features, aspects, and advantages of the present invention will become apparent to those skilled in the art from the following detailed descriptions taken in conjunction with the accompanying drawings, illustrating the preferred embodiments of the present invention.

### BRIEF DESCRIPTION OF THE DRAWINGS

Referring now to the attached drawings which form a part of this original disclosure:

FIG. 1 is a schematic diagram illustrating the overall configuration of an image forming apparatus in accordance with a first preferred embodiment of the present invention;

FIG. 2 is a flow chart showing a series of password-analyzing processes by an image forming apparatus shown in FIG. 1;

FIG. 3 is a schematic diagram illustrating the entire configuration of an image forming apparatus in accordance with a second preferred embodiment of the present invention; and

FIG. 4 is a flow chart showing a series of password-analyzing processes by an image forming apparatus shown in FIG. 3.

### DETAILED DESCRIPTION OF THE PREFERRED EMBODIMENTS

Preferred embodiments of the present invention will now be described with reference to the accompanying drawings. It will be apparent to those skilled in the art from this disclosure that the following descriptions of the embodiments of the present invention are provided for illustration only and not for the purpose of limiting the invention as defined by the appended claims and their equivalents.

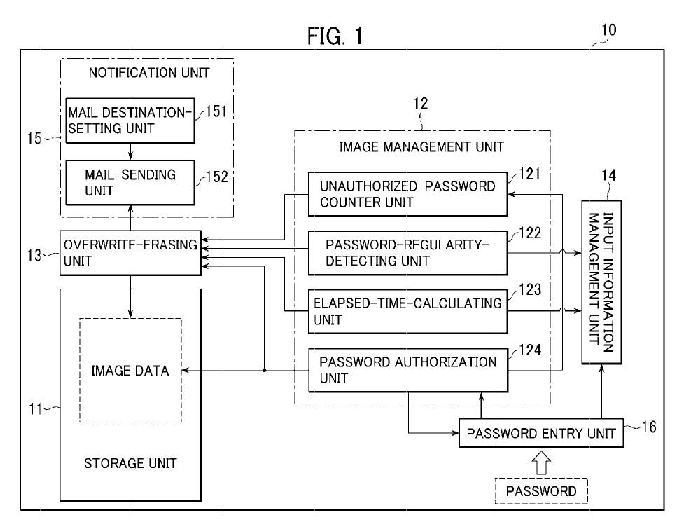

The present invention provides an image forming apparatus and image security system and program. Preferred embodiments of the present invention will, hereinafter, be described with reference to FIGS. 1-4.

The image forming apparatus of the present invention can be realized by, but is not limited to, a computer that executes instructions to perform predetermined operations, processes and/or functions for the image formation, wherein the contents of instructions are defined by a program. The program is an organized list of instructions that, when executed, causes a computer to perform predetermined operations, processes and/or functions. The program may typically include, but is not limited to, a software program. The program sends instructions to each computer unit to enable the units to perform each assigned operation, process and/or function that can be realized by cooperation of software program and computer hardware.

All or part of the program may be provided by, but not be limited to, any computer-readable storage medium or device, so that the program is read out of the storage medium or device and then installed into the computer to be executed. Alternatively, the program may also be provided to the computer through any available communication network.

### FIRST EMBODIMENT

FIG. 1 illustrates the overall configuration of an image forming apparatus in accordance with a first embodiment of the present invention. An image forming apparatus 10 may comprise a storage unit 11, an image management unit 12, an overwrite-erasing unit 13, an input information management unit 14, a notification unit 15, and a password entry unit 16.

The storage unit 11 is configured to store image data and permit the stored image data to be read out upon request.

The image management unit 12 is configured to control the erasing and outputting of the image data from the storage unit 11. The image management unit 12 may further comprise a plurality of sub-units that cooperate with each other to control the erasing and outputting operations. Thus, the image management unit 12 may typically include, but not be limited to, an unauthorized-password counter unit 121, a password-regularity-detecting unit 122, a elapsed-time-calculating unit 123, and a password authorization unit 124.

The unauthorized-password counter unit 121 is configured to cooperate with the password authorization unit 124 so as to count up the number of the password entries that are not authorized by the password authorization unit 124. If the counted number exceeds a predetermined reference number, then the unauthorized-password counter unit 121 denies any access that is associated with the unauthorized password. Thus, the unauthorized-password counter unit 121 sends the overwrite-erasing unit 13 an instruction to erase the image data and inhibit any recovery of the erased data. It will be apparent to a person skilled in the art that the reference number should be determined by taking into account the low probability that the erroneous password entry will be repeated by an authorized person who possesses an access right.

The password-regularity-detecting unit 122 is configured to communicate with the input information management unit 14, in order to analyze the entered password information, which is stored in the input information management unit 14. This analysis is made under predetermined conditions, so that the password-regularity-detecting unit 122 detects the regularity of the entered password information, which will hereinafter be referred to as “password-regularity”. Verifying whether the entered password information has a predetermined unallowable level of password-regularity allows the detection of the password-regularity. The predetermined conditions for detecting the password-regularity may be provided by setting an unallowable level or range of regularity of an arithmetical series or a character series, e.g., an arithmetical progression or a geometrical progression. The regularity of the password is determined by comparing the latest entered password to the past-entered passwords. If the latest entered password has a common pattern to the past entered passwords, then the regularity-detecting unit 122 recognizes that the password information has the predetermined unallowable level or range of regularity, and the regularity-detecting unit 122 makes this access unauthorized, and sends the overwrite-erasing unit 13 the erasing instruction.

The elapsed-time-calculating unit 123 is configured to cooperate with the input information management unit 14, in order to calculate a period of time between a last password entry time and a latest password entry time that is subsequent to the last password entry time. The password entry is stored in the input information management unit 14. The input information management unit 14 informs the elapsed-time-calculating unit 123 of the password entry time to enable the elapsed-time-calculating unit 123 to calculate the time period. The elapsed-time-calculating unit 123 informs the input information management unit 14 of the calculated time period. If the time period calculated by the elapsed-time-calculating unit 123 is equal to or less than a predetermined reference time period, then the input information management unit 14 recognizes the access to be unauthorized, because the unauthorized user is likely to enter a password repeatedly within a short time period in order to attempt unauthorized access. Upon recognition of the unauthorized access, the input information management unit 14 sends the overwrite-erasing unit 13 the erasing instruction.

The overwrite-erasing unit 13 performs an overwrite erasing operation, which is quite different from the known erasing method, in order to erase the image data, to which the unauthorized access was attempted, and to make it impossible to recover the image data once erased.

The password authorization unit 124 is configured to receive the password information entered from the password entry unit 16, and to verify whether or not the entered password is identical with a reference password that has been previously set for the subject image data. The password authorization unit 124 is also configured to communicate with the storage unit 11 and with the overwrite-erasing unit 13. If the password authorization unit 124 has verified that the entered password is identical with the reference password, then the password authorization unit 124 sends the storage unit 11 a request for outputting the image data, and also sends the overwrite-erasing unit 13 an instruction to overwrite-erase the image data. If the password authorization unit 124 has verified that the entered password is not identical with the reference password, then the password authorization unit 124 denies the request for access and sends the password entry unit 16 a request for entry of the password again.

In accordance with the overwrite-erasing instruction from the password authorization unit 124, the overwrite-erasing unit 13 performs an overwrite erasing operation to erase the image data so as to make it impossible to recover the once-erased data. For example, the overwrite erasing operation will overwrite the image data with “0 (zero)” or random data such as random numbers and change the image data into data that is different from the image data, thereby making it impossible to recover the original image data from the different data.

As described above, the conventional method of erasing data by the conventional security system is to merely erase the management information of a file, while having the content of data remain unchanged. This means that the unauthorized user is allowed to recover the once-erased image data that is confidential.

It will be apparent that the above described overwrite-erasing operation is effective to inhibit the unauthorized user to recover the original image data once erased.

When the password authorization unit 124 authorizes the password and allows the access to the image data, the password authorization unit 124 sends the storage unit 11 a request for accepting the access to the image data. After the image data was fetched from the storage unit 11, the password authorization unit 124 can optionally send the overwrite-erasing unit 13 the request for a overwrite erasing operation, in order to keep the security of management of the image data after the image data has been used.

The overwrite-erasing unit 13 is configured to cooperate with the notification unit 15, in order to perform an additional notification function of forwarding an e-mail to a predetermined destination upon receipt of the erasing instruction from the image management unit 12, wherein the e-mail is to inform that the original data will be erased or has been erased and thus it is no longer possible to use or recover the original image data. The overwrite-erasing unit 13 sends the notification unit 15 a request for forwarding the e-mail to the predetermined destination. Upon receipt of this request, the notification unit 15 forwards the e-mail to the destination.

The input information management unit 14 is configured to store the password that was entered from the password entry unit 16, and a password input time when the password entered. The input information management unit 14 permits the regularity-detecting unit 122 and the elapsed-time-calculating unit 123 to use the entered password and the password input time, respectively.

The password entry unit 16 is configured to serve as an input interface that sends the entered password information to the image management unit 12 and the input information management unit 14 as well as that restricts the password entry.

The notification unit 15 is configured to forward the above-described e-mail to the predetermined destination in accordance with the request from the overwrite-erasing unit 13. The notification unit 15 may comprise, but not be limited to, a plurality of sub-units that cooperate with each other to perform the above-described notification function. The e-mail management unit 15 may, for example, comprise a mail destination-setting unit 151 and a mail-sending unit 152.

The mail destination-setting unit 151 is configured to set a mail destination for every image data that was stored in the storage unit 11.

The mail-sending unit 152 forwards the e-mail to the mail destination as set by the mail destination-setting unit 151, wherein the e-mail is to inform that the image data was erased or is to be erased. It is also possible as a modification for the e-mail to have an attachment file that consists of the original image data for the purpose of sending the original image data to the destination, even if the original image data is erased from the storage unit 11, and any recovery of the once-erased image data is unavailable.

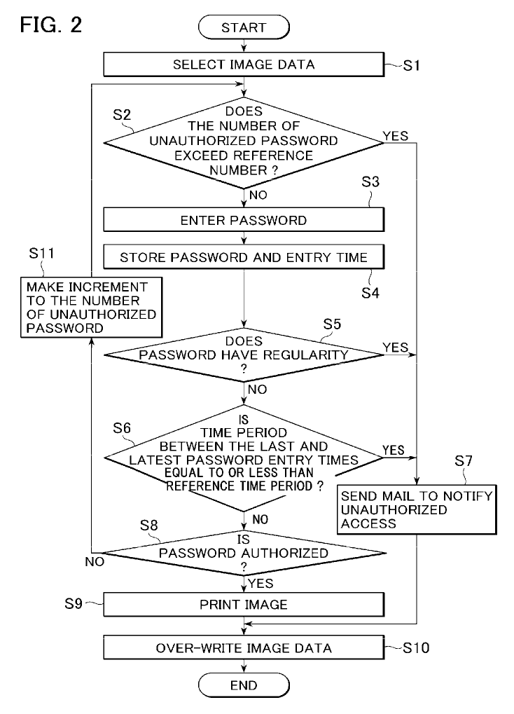

With reference to FIG. 2, descriptions will be made of a series of processes for password analysis in the above-described image forming apparatus 10. FIG. 2 is a flow chart showing a series of password-analyzing processes by the above-described image forming apparatus.

In Step S1, one or more image data to be outputted are selected from a group of image data stored in the storage unit 11. Operating an interface provided to the image forming apparatus 10 may select the image data.

In Step S2, the unauthorized-password counter unit 121 counts up the number of the password entries that are unauthorized by the password authorization unit 124. The unauthorized-password counter unit 121 verifies whether the counted number exceeds the predetermined reference number as the maximum allowable number. When the counted number exceeds the predetermined reference number, the unauthorized-password counter unit 121 determines that access is unauthorized. The process will then proceed to Step S7.

If the counted number does not exceed the predetermined reference number, then the process proceeds to Step S3, in which an interface that is not illustrated permits a further entry of password.

In Step S4, the entered password and the time of entry of the password are stored in the input information management unit 14.

In Step S5, the password-regularity-detecting unit 122 detects the regularity of the entered password by verifying whether the entered password has a predetermined unallowable level or range of password-regularity with reference to an arithmetical series or a character series, for example, an arithmetical progression or a geometrical progression. The level of the password-regularity is determined by comparing the latest entered password to the past-entered passwords. When the latest entered password includes a common pattern to the past-entered password, the password-regularity-detecting unit 122 recognizes that the entered password has the predetermined unallowable level or range of password-regularity. For example, when the latest entered password is “AAAC” and the past-entered passwords are “AAAA” and “AAAB”, and then the password-regularity-detecting unit 122 recognizes that latest entered password “AAAC” has a common pattern “AAAX” to the past-entered passwords “AAAA” and “AAAB”, and that the entered password has the predetermined unallowable level or range of password-regularity. As a result, the password-regularity-detecting unit 122 determines that access is unauthorized, and the process proceeds to Step S7.

When the password-regularity-detecting unit 122 recognizes that entered password does not have the predetermined unallowable level or range of password-regularity, then Step S6 will be taken.

In Step S6, the elapsed-time-calculating unit 123 extracts the password entry times that were stored in Step S4, in order to calculate a period of time between a last password entry time and a latest password entry time that is subsequent to the last password entry time. The elapsed-time-calculating unit 123 verifies whether the calculated time period exceeds the predetermined reference time period or is equal to less than the predetermined reference time period. If the calculated time period is equal to or less than the predetermined reference time period, then access is denied, and the process proceeds to Step S7. If the calculated time period exceeds the predetermined reference time period, then the process proceeds to Step S8.

In Step S7, when access has been denied in Step S2, Step S5 or Step S6, the e-mail is forwarded to the predetermined destination to notify that unauthorized access was attempted. In Step S10, the image data, to which the unauthorized access was attempted, is subject to the above-described overwriting erasure operation which overwrites the image data with random data, and as a result no recovery of the original image data is available.

On the other hand, when access is authorized and the process proceeds to Step S8, the password authorization unit 124 will authorize access. It will be verified whether or not the entered password is identical with the previously stored reference password. If the entered password is identical with the previously stored reference password, then the image data, to which the access has been made, becomes available. In Step S9, the image data is printed out, before the image data is then erased by the above-described overwriting erasure operation in Step S10.

If the entered password is not identical with the previously stored reference password, then the process proceeds to Step S11, in which an increment by “1” is added to the counting number of the password entries that were denied, followed by return to Step S2. A series of those processes in Steps S2 through Step S8 will be repeated until the image data is erased either after the access had been authorized whereby the image data was fetched from the storage unit 11, or after the access had been unauthorized in Step S2, Step S5 or Step S6.

As described above, the image forming apparatus 10 comprises the above-described plural function units that cooperate with each other to perform the operations to fulfill the desired reliance security, in which an access to the image data is unauthorized unless at least one of the following conditions is satisfied.

With regard to the first condition, if an entered password is not identical with the reference password that has previously been set for the subject image data, then the entered password is denied. The number is counted of the password entries that have been denied. If the counted number exceeds the predetermined reference number, then this access is unauthorized, which is accompanied with the password entries that have been denied. The image data, to which the unauthorized access was attempted, is then subjected to the above-described over-write erasure that makes it impossible to recover the once-erased image data.

With regard to the second condition, if an entered password has the predetermined unallowable level of password-regularity, then the access with this entered password is also unauthorized. The image data, to which the unauthorized access was attempted, is then subjected to the above-described over-write erasure that makes it impossible to recover the once-erased image data.

With regard to the third condition, a time period is measured between the last password entry time and the latest password entry time subsequent to the last password entry time. If the measured time period is equal to or less than the predetermined reference time period, then the access accompanied with the last and latest password entries is unauthorized. The image data, to which the unauthorized access was attempted, is then subjected to the above-described over-write erasure that makes it impossible to recover the once-erased image data.

In other words, the image forming apparatus 10 is configured to distinguish an access that should be authorized from another access that should be unauthorized, so as to realize a highly accurate detection of the access that should be unauthorized. The image forming apparatus 10 is also configured to erase the image data, to which the unauthorized access was attempted, so that no recovery of the once-erased image data is available. Thus, the image forming apparatus 10 can realize a highly reliable and effective security management.

In addition, the image forming apparatus 10 is configured to notify by e-mail one or more destinations of the fact that the unauthorized access was attempted, so that the user who possesses the image data and a system manager can be advised of that fact. In order to improve the security, some additional countermeasures can be taken to any further access that should be unauthorized. Typical example of the additional countermeasures may include, but be not limited, to changing the previously set reference password and/or a file name for the image data. The above-described additional countermeasures might be effective to make it more difficult to acquire the confidential image data by any unauthorized access.

### SECOND EMBODIMENT

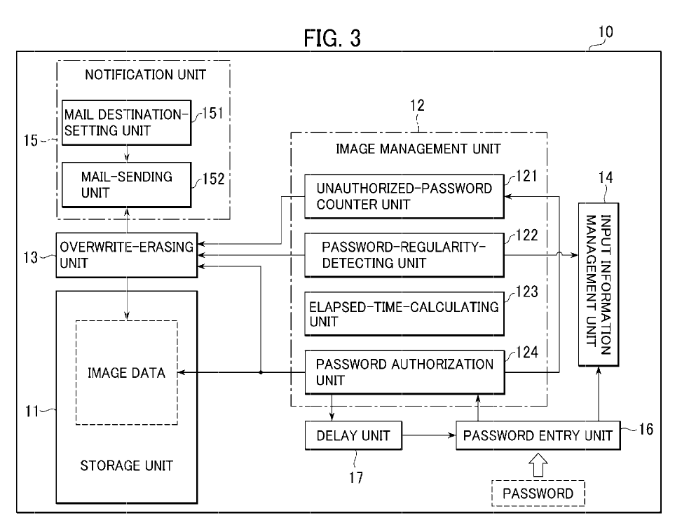

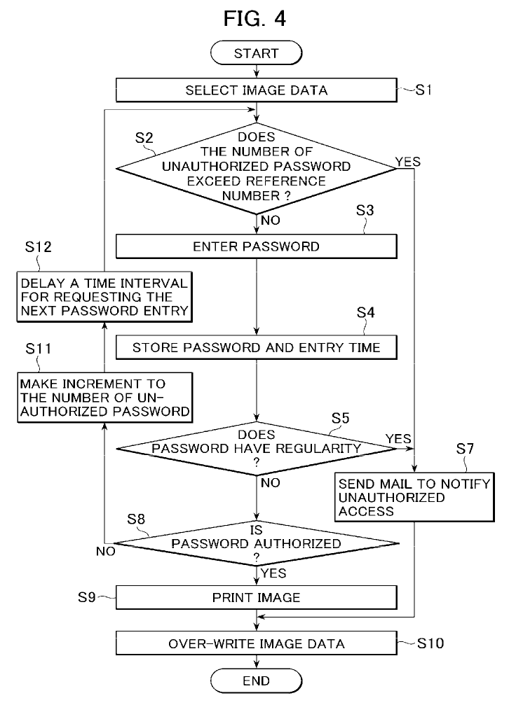

Another image forming apparatus in accordance with a second embodiment of the present invention will hereinafter be described with reference to FIGS. 3 and 4. The following descriptions with reference to FIG. 3 will focus on a substantive difference of the second embodiment from that of the first embodiment, while omitting the duplicate descriptions thereof.

FIG. 3 illustrates the entire configuration of an image forming apparatus in accordance with the second preferred embodiment of the present invention. A difference in configuration of the image forming apparatus of the second embodiment from that of the first embodiment is that the image forming apparatus 10 further comprises an additional function unit, for example, a delay unit 17 that cooperates with the password entry unit 16 and the password authorization unit 124. The delay unit 17 delays requesting a password entry again after the last password entry was denied. If the password authorization unit 124 has verified that the entered password is not identical with the reference password, then the password authorization unit 124 denies the request for access and sends the delay unit 17 a request for entry of the password again. The delay unit 17 further delays transferring the request to the password entry unit 16, so that the password entry unit 16 delays receiving the request and issuing it to the user. In other words, the delay unit 17 extends a period between the time that the entered password was denied and a time of issuing the request for entry of the password again. Issuance of the request for entry of the password again allows the entry of the password again. Namely, after the entered password was denied, then the re-entry of the password is inhibited until the request for re-entry of the password is issued.

Provision of the delay unit 17 may optionally permit omitting the elapsed-time-calculating unit 123 that calculates the time period between the last-denied password entry time and the password re-entry time. Namely, the delay unit 17 renders unnecessary the time-calculating function of the elapsed-time-calculating unit 123 because the delay unit 17 defines the minimum time interval between the last-denied password entry and the next password entry.

FIG. 4 is a flow chart showing a series of password-analyzing processes by the above-described image forming apparatus. The following descriptions with reference to FIG. 4 will focus on a substantive difference of the second embodiment from that of the first embodiment, while omitting the duplicate descriptions thereof.

A difference in process of operations of the image forming apparatus of the second embodiment from that of the first embodiment is that Step 12 is newly added, which is executed by the delay unit 17 after Step S11, and that there is omitted the Step S6 which is executed by the elapsed-time-calculating unit 123 in accordance with the above-described first embodiment.

As described above, the image forming apparatus 10 in accordance with the second embodiment provides not only the same effects and advantages as them of the first embodiment, but also the last-mentioned additional effect that the re-entry of the password again is inhibited for the predetermined time period since the last entered password was denied.

The above described image forming apparatus 10 can be realized by, but not be limited to, an information processing device such as a personal computer with a storage unit, for example, a hard disk, however, without any printing function.

It will be apparent to a person skilled in the art that the present invention is applicable not only to the image information device provided with the storage medium for storing the image data such as hard disk but also to a confidential data security system that manages confidential data that may include, but be not limited to, different types of data from image data.

The term “password authorization” as used herein to describe the present invention has the same technical meaning as “password authentication”.

The term “unit” as used herein to describe the image forming apparatus 10 includes hardware and/or software that is constructed and/or programmed to carry out the desired function.

The term “predetermined” as used herein to describe the image forming apparatus means that an authorized user who possesses the image data and/or a system manager have previously given or set parameters such as the number.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. An apparatus comprising:
a storage unit that stores data;
an overwrite-erasing unit that performs an overwrite-erasure of the data stored in the storage unit; and
a management unit that analyzes a password that has been entered for access to the data in order to determine whether the access should be authorized or unauthorized, the management unit sending the overwrite-erasing unit a first request for the overwrite-erasure when making the access unauthorized, or sending the storage unit a second request for allowing access to the data when making the access authorized.

2. The apparatus according to claim 1, wherein the management unit further comprises:
a password authorization unit that determines whether the password should be authorized or unauthorized, and makes the password authorized or unauthorized; and
an unauthorized-password counter unit that counts the number of password entries that have been unauthorized by the password authorization unit, the unauthorized-password counter unit verifying whether or not the counted number exceeds a predetermined reference number, and sending the overwrite-erasing unit the first request for the overwrite-erasure when the counted number exceeds the reference number.

3. The apparatus according to claim 1, wherein the management unit further comprises:
a password-regularity-detecting unit that verifies whether or not the password has an unallowable level of password-regularity, the password-regularity-detecting unit sending the overwrite-erasing unit the first request for the overwrite-erasure when the password has the unallowable level of password-regularity.

4. The apparatus according to claim 1, wherein the management unit further comprises:
an elapsed-time-calculating unit that measures a time period between a last password entry time and a latest password entry time that is subsequent to the last password entry time, the elapsed-time-calculating unit comparing the measured time period to a predetermined reference time period, and sending the overwrite-erasing unit the first request for the overwrite-erasure when the measured time period is equal to or less than the reference time period.

5. The apparatus according to claim 1, wherein the management unit further comprises:
a password authorization unit that determines whether the password should be authorized or unauthorized, and makes the password authorized or unauthorized;
a password entry unit that enters the password into the password authorization unit; and
a delay unit that delays requesting the password entry unit for a password entry again after the password is made unauthorized by the password authorization unit.

6. The apparatus according to claim 1, further comprising:
a notification unit that sends a predetermined destination a notice to the effect that the overwrite-erasing unit will perform or has performed the overwrite-erasure.

7. The apparatus according to claim 1, wherein the management unit sends the overwrite-erasing unit a third request for the overwrite-erasure, after the access had been authorized and the data has been fetched from the storage unit.

8. A storage medium containing executable instructions that, when executed, cause one or more processors to perform the steps comprising:
analyzing a password that has been entered for access to data stored on a storage unit in order to determine whether the access should be authorized or unauthorized;
performing an overwrite-erasure of the data when making the access unauthorized; and
allowing access to the data when making the access authorized.

9. The storage medium according to claim 8, wherein the step of analyzing the password further comprises:
determining whether the password should be authorized or unauthorized, and making the password authorized or unauthorized; and
counting the number of password entries that have been unauthorized to verify whether or not the counted number exceeds a predetermined reference number, and
wherein the step of performing the overwrite-erasure further comprises:
performing the overwrite-erasure when the counted number exceeds the reference number.

10. The storage medium according to claim 8, wherein the step of analyzing the password further comprises:
verifying whether or not the password has an unallowable level of password-regularity, and
wherein the step of performing the overwrite-erasure further comprises:
performing the overwrite-erasure when the password has the unallowable level of password-regularity.

11. The storage medium according to claim 8, wherein the step of analyzing the password further comprises:
counting a time period between a last password entry time and a latest password entry time that is subsequent to the last password entry time; and
comparing the measured time period to a predetermined reference time period, and
wherein the step of performing the overwrite-erasure further comprises:
performing the overwrite-erasure when the measured time period is equal to or less than the reference time period.

12. The storage medium according to claim 8, wherein the step of analyzing the password further comprises:
determining whether the password should be authorized or unauthorized, and making the password authorized or unauthorized; and
delaying a request to re-enter another password after the password is made unauthorized.

13. The storage medium according to claim 8, wherein the one or more processors further perform the step comprising:
sending a predetermined destination a notice to the effect that the overwrite-erasure will be performed or has been performed.

14. The storage medium according to claim 8, wherein the one or more processors further perform the step comprising:
performing the overwrite-erasure after the access had been authorized and the data has been used.

15. A method comprising the steps of:
analyzing a password that has been entered for an access to data stored on a storage unit in order to determine whether the access should be authorized or unauthorized;
performing an overwrite-erasure of the data when making the access unauthorized; and
allowing access to the data when making the access authorized.

16. The method according to claim 15, wherein the step of analyzing the password further comprises:
determining whether the password should be authorized or unauthorized, and making the password authorized or unauthorized; and
counting the number of password entries that have been unauthorized to verify whether or not the counted number exceeds a predetermined reference number, and
wherein the step of performing the overwrite-erasure further comprises:
performing the overwrite-erasure when the counted number exceeds the reference number.

17. The method according to claim 15, wherein the step of analyzing the password further comprises:
verifying whether or not the password has an unallowable level of password-regularity, and
wherein the step of performing the overwrite-erasure further comprises:
performing the overwrite-erasure when the password has the unallowable level of password-regularity.

18. The method according to claim 15, wherein the step of analyzing the password further comprises:
counting a time period between a last password entry time and a latest password entry time that is subsequent to the last password entry time; and
comparing the measured time period to a predetermined reference time period, and
wherein the step of performing the overwrite-erasure further comprises:
performing the overwrite-erasure when the measured time period is equal to or less than the reference time period.

19. The method according to claim 15, wherein the step of analyzing the password further comprises:
determining whether the password should be authorized or unauthorized, and making the password authorized or unauthorized; and
delaying a request to re-enter another password after the password is made unauthorized.

20. The method according to claim 15, further comprising the step of:
sending a predetermined destination a notice to the effect that the overwrite-erasure will be performed or has been performed.

21. The method according to claim 15, further comprising the step of:
performing the overwrite-erasure after the access had been authorized and the data has been used.
